(19) United States
(12) Patent Application Publication
(10) Pub. No.: US 2025/0343437 A1
(43) Pub. Date: Nov. 6, 2025

(54) BATTERY BACKUP SYSTEM FOR FAIL-SAFE ELECTRIC ACTUATORS

(71) Applicant: Max-Air Technology, Inc., Wentzville, MO (US)

(72) Inventors: Brian J. Wheeler, Wentzville, MO (US); Bryan Tracy, Wentzville, MO (US); Dan Parsons, Wentzville, MO (US)

(21) Appl. No.: 19/199,569

(22) Filed: May 6, 2025

Related U.S. Application Data
(60) Provisional application No. 63/643,225, filed on May 6, 2024.

(51) Int. Cl. H02J 9/06; F16K 31/04; H02J 7/00

(52) U.S. Cl. CPC H02J 9/06; F16K 31/046; H02J 7/0024

(57) ABSTRACT

A lithium-iron-phosphate battery backup system for use with an electric actuator. The battery backup system includes a controller for detecting a power failure and supplying backup power to the actuator to close a valve or damper connected to the actuator. The system can also detect out of range environmental conditions, and defects to the battery backup system. The battery backup system also includes a system for boosting the current and voltage of the batteries in the system.

### CROSS-REFERENCE TO RELATED APPLICATIONS

The present invention claims priority to and the benefit of U.S. Provisional Patent Application No. 63/643,225, filed May 6, 2024, the contents of which are incorporated herein by reference and made a part hereof.

### FEDERALLY SPONSORED RESEARCH OR DEVELOPMENT

N/A

### FIELD OF THE INVENTION

The present invention is directed to an internal backup battery system utilizing Lithium-Iron-Phosphate cells and a control board coupled to the cells which can be placed in an actuator used in processes for controlling fluid flow.

### DESCRIPTION OF THE PRIOR ART

Valves and damper systems have been utilized to control the flow of various fluids in industrial and municipal fluid flow processes since the beginning of the industrial age. Such processes include potable water, wastewater, chemical treatments, hydrocarbon refining, extraction and pumping systems, power generation, and flood control systems to name a few.

The systems for controlling the fluids flow started as manually operated devices. Maintenance personnel were charged with adjusting and positioning such flow control devices by hand to meet the various requirements of the institution where they were installed. However, with the growth of the processes requiring flow control and the constant need for better control and more complex systems, the flow control devices were fitted with actuators that allowed for better and more automatic control of the fluid.

Initially, simple pneumatic quarter-turn actuators were added to the flow control devices, which utilized compressed air to provide the driving force to reposition the devices. Over time, electric actuators proved to be more economical and easier to install and maintain than pneumatic systems. However, a problem with electric actuators is they have no means of providing fail-safe positioning like pneumatic systems in the event of a power outage.

In order for electric actuators to function in a fail-safe mode, they must be either (a) connected to a generator backup system; (b) connected to an external battery backup system; or (c) have an internal energy source to provide the power reserves to park the fluid control devices in the correct position for a power outage.

In certain instances, generator and external battery backup systems are either too expensive or otherwise unsuitable to be utilized. In those situations, NiCad batteries, Super-capacitors and Lithium-Ion cells have been used as internal energy sources (i.e., option (c)). However, each of these options are problematic.

NiCad battery systems have a charge memory, and gradually degrade each time they are charged or discharged. Additionally, these systems require fairly high energy levels to charge and a large number of cells are needed to provide the voltage and current needed by the large actuators used today.

Super-capacitor systems do not have the same charge memory issues as the NiCad battery systems. However, similar to such systems, a large number of capacitors are needed to provide the voltage and current needed by the actuators. This requires a prohibitively large space for the capacitors, and can be very costly.

Lithium-Ion cells also do not have a problem with charge memory. They also handle environmental extremes better than other systems. However, the technology to create the cells is inherently complex, and there are issues with cell stability when the structure is damaged. Additionally, charging these cells can be complicated and require monitoring. Moreover, individual cells improperly feed off each other when in close proximity or when used outside their specific temperature and charge ranges, and are subject to individual cell balancing requirements.

The present invention provides an internal energy source for providing a fail-safe mode for an actuator without the detrimental side effects encountered by prior solutions.

### SUMMARY OF THE INVENTION

The present invention provides an internal energy source in the form of battery cells using Lithium-Iron-Phosphate (LiFePO4) chemistry. The cells provide power for fail-safe positioning of low-power electric valve and damper actuators in the event of a mains power line failure. The actuators are typically installed in large (and often remote) industrial processing systems to control the flow of fluids. The invention also includes circuitry to detect a power failure and to boost the voltage and current of the battery cells to move the valve or damper actuator. In one instance, the invention relates to using one or more LiFePO4 cells preferably with boost circuitry to convert the cell's output up to 24 volts (V) at up to 8 Amps (A).

LiFePO4 battery cells are substantially safer than Lithium-Ion cells. The additional safety comes in the form of increased thermal runaway temperature of about 250 degrees Celsius (compared to a thermal runaway temperature of 150 degrees Celsius in Lithium-Ion batteries). LiFePO4 chemistry batteries also do not produce oxygen when ignited, and are more self-extinguishing, whereas in lithium ion batteries the flame produces oxygen and feeds the flame which can lead to explosion. The LiFePO4 chemistry also allows for reduced cell count (over prior technologies) due to increased current output, and therefore increased power output. This also means that a less complex charge/discharge control is needed because the cells can be separated, eliminating complicated balancing management found in the prior Lithium-Ion systems. The LiFePO4 battery cells can be coupled to a control board having circuitry for monitoring the cells, charging the cells, and discharging and boosting the cells when needed. The battery cells and control board can be provided in easily replaceable shrink wrapped packs for internal installation in the actuator. The design primarily uses two larger printed circuit (PCB) assemblies to achieve this-One Battery Pack (BP) and one Battery Management System (BMS).

In accordance with an aspect of the invention, the BP includes of one or more Lithium Iron Phosphate (LiFePO4) cells. The contacts for these cells are connected to the BMS directly for managing the configuration of the batteries based on mains power being present or not. The one or more cells are also accompanied by their individual chargers and a voltage-sensing circuit that monitors potential damage to the cells from overuse or temperatures outside of their operating range. Once a cell shows a sign of damage, an indicator is activated permanently to show this and warn the user of the potential damage.

The BMS contains the battery contacts and a system to switch them from output mode (Mains off) to charge mode (Mains on) based on mains power availability. The BMS can also hold an output circuit, known as or referred to as the Boost Circuit (or boost circuitry, etc.). This circuit uses high current, and low voltage from the batteries and converts it to higher voltage, and lower current. This output is sent to the actuator control board where the actuator will rotate the valve or move the damper to the selected fail-safe position. The BMS also contains a temperature warning sensor, which can be connected to a control system to notify users that temperatures are exceeding the batteries' recommended operating conditions and should be addressed.

The one or more LiFePO4 cells are each connected to relays (e.g., K1 and K3) on the BMS which, when supplied with mains power, will separate the two cells and connect each to its own charging circuit. Also, when mains power is supplied a third latching type relay (K2) is switched on to be prepared for backup operation. Tis relay's main purpose is to disconnect the two batteries after a fail-safe move has been completed. Disconnecting the batteries can be critical to prevent loss of charge to damaging levels. When mains power is disconnected or lost, K1 and K3 will switch the cells to a series connection with one another through the contacts on K2 which were set up once power was applied. This allows the output of the cells to head to the boost circuit where the voltage and current of the batteries will be converted to meet the needs of the actuator.

The boost circuitry is needed in certain instances because the output from each of the cells is typically 3.3 Volts at a maximum of 33 Amps, which comes out to 108.9 Watts (Volts* Amps=Watts). This is plenty of power, but the Brushless Direct Current Motor (BLDC) that is typically encountered in the actuator needs 24 Volts to operate.

The key components to make this conversion within one preferred Boost Circuit are an Inductor, a MOSFET, a controller, a diode, and a capacitor. The inductor is the main component in one aspect of the present design to create this large jump in voltage. When a voltage is applied to the inductor, current slowly passes through the inductor but speeds up over time. When the voltage is removed, the inductor continues to push current through, but it slows over time. The controller connects to the gate of the MOSFET, which either connects the output of the inductor to the diode and capacitor, or connects the output to ground. For this application, the duty cycle (% of time the MOSFET is active) is calculated by:

$$D = 1 - ( INPUT\_VOLTS / OUTPUT\_VOLTS )$$

This duty cycle in this application comes out to ˜73%, which means that the MOSFET will be charging the inductor ˜73% of the time and the remaining time will have the inductor sending its charge through the diode and into the capacitor. This can be entirely handled by the controller which balances the output to the steady 24 Volts the BLDC motor needs.

The BMS or BP control board can include a charging circuit and a discharge circuit. The charging circuitry receives power from the mains power line to charge the cells. The control board can also connect to a voltage boost system as part of the circuitry on the board. The boost circuitry increases the voltage to a value to drive the motor in the actuator to place the valve or damper in the correct fail-safe position in the event of a power outage on the mains power line.

The control board can be coupled to an end-of-travel switch associated with the valve or damper connected to the actuator. The control board is configured to disconnect the Lithium-Iron-Phosphate cells (and any additional cells in the pack) when the control board senses activation of the end-of-travel switch.

In accordance with one aspect of the invention, an internal battery backup system for an electric actuator connected to a valve or damper having a housing with an internal cavity is provided. The system comprises a first Lithium-Iron-Phosphate cell configured for placement in the internal cavity of the actuator. A control board is coupled to the first Lithium-Iron-Phosphate cell having circuitry for sensing a fault condition and activating the first Lithium-Iron-Phosphate cell to provide power to initiate fail-safe positioning by the actuator.

The system can further include a second Lithium-Iron-Phosphate cell configured for placement in the internal cavity of the actuator coupled to the control board. The first and second cells can be formed into a battery pack. Additional cells can be included as needed.

The control board can be coupled to the mains power line providing power to the actuator and is configured to sense a loss of power in the mains power line. The control board is configured to activate the first Lithium-Iron-Phosphate cell (and any additional cells coupled to the board) when a loss of power is sensed in the mains power line.

The control board can be coupled to a temperature sensing device or otherwise sense when temperature conditions inhibit charging of the battery cells, and provide a signal indicating the lack of charging. In this regard, the control board can be configured to compare a temperature reading from the temperature sensing device with a set limit temperature range and provide a signal if the temperature reading is outside the set limit temperature range. The signal can be provided to a controller or automation logic (e.g., a field control system) for the processing system.

Additionally, the control board can be configured to determine a voltage level of the first Lithium-Iron-Phosphate cell (and any additional cells coupled to the board) and to provide a signal if the voltage level of the first Lithium-Iron-Phosphate cell (or additional cells) falls below a set limit. This typically indicates a faulty battery pack that requires replacement.

The first Lithium-Iron-Phosphate cell and the second Lithium-Iron-Phosphate cell can be coupled in parallel. This allows for separately charging each cell.

The control board includes a charging circuit and a discharge circuit. The charging circuitry receives power from the mains power line to charge the cells. The control board can also include a voltage boost system as part of the circuitry on the board. The boost circuitry increases the voltage to a value to drive the motor in the actuator to place the valve or damper in the correct fail-safe position in the event of a power outage on the mains power line.

The control board can be coupled to an end-of-travel switch associated with the valve or damper connected to the actuator. The control board is configured to de-active the first Lithium-Iron-Phosphate cell (and any additional cells in the pack) when the control board senses activation of the end-of-travel switch.

In one aspect of the invention, a direct current voltage from the first and second Lithium-Iron-Phosphate cells is directed through an inductor to a capacitor in the voltage boost system. The voltage boost system can include a MOSFET gate that enables current to flow through the inductor to ground when in an on position (i.e., the boost circuit is in a drain phase). The MOSFET gate can then enable current to flow through the inductor to the capacitor to the actuator motor drive when in an off position (i.e., the boost circuit is in a charge cycle).

In accordance with another aspect of the invention, an internal battery backup system for an electric actuator comprises a first Lithium-Iron-Phosphate battery pack containing a first Lithium-Iron-Phosphate cell and a second Lithium-Iron-Phosphate cell. A power and management unit is connected to the first Lithium-Iron-Phosphate battery pack and is configured to charge the cells in the Lithium-Iron-Phosphate battery pack from a mains power supply and to discharge the cells to the electric actuator upon sensing a fault condition in the mains power supply.

The system can also include a second Lithium-Iron-Phosphate battery pack containing a first Lithium-Iron-Phosphate cell and a second Lithium-Iron-Phosphate cell connected to the power and management unit. Additional packs can be utilized as needed.

The internal battery backup system can include a boost system in the power and management unit which directs current from the cells in the first Lithium-Iron-Phosphate battery pack through a capacitor to provide a voltage to the actuator greater than a voltage of the battery pack.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of an actuator for controlling a valve or damper in a fluid flow process;

FIG. 2 is a schematic view of an internal battery pack for use in an actuator to provide power for a fail-safe mode in the event of a loss of mains power in accordance with an aspect of the present invention;

FIG. 3 is a schematic diagram illustrating typical power and information flow of an actuator controlling a valve or damper in a fluid processes system;

FIG. 4 is a schematic diagram illustrating activation of the battery pack of the present invention in the event mains power is loss in the process of FIG. 3;

FIG. 5 is an internal perspective view of an actuator showing component details;

FIG. 6 is an additional internal perspective view of an actuator showing details;

FIG. 7 is a schematic view of a battery cell management system;

FIG. 8 is a schematic view of a battery output system, temperature monitoring and fault systems; and,

FIG. 9 is a schematic view of a motor drive system with logic and fault systems.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention utilizes Lithium-Iron-Phosphate (LiFePO4) chemistry to provide safer battery cells having a higher energy density and compact size compared to prior battery cell technology, for use in providing an internal fail-safe power to actuators in a processing or similar system. The actuators are typically responsible for opening and closing valves and dampers for fluid control in the system. The LiFePO4 cells can be fabricated for high capacity variants having 3.5 vdc (volts direct current) at 20 Amps (Amperes) (for short duration bursts of less than three minutes) without any detrimental side effects. In contrast, prior cell technology (e.g., NiCad and Lithium-Ion cells) are typically 1.5 to about 3.5 vdc and rated at 300to approximately 600 mAmps. Thus, fewer LiFePO4 cells are need than prior technologies to provide sufficient power. The LiFePO4 cells can be formed in modular packs that are combined with control circuitry and are easily installed and replaced as necessary.

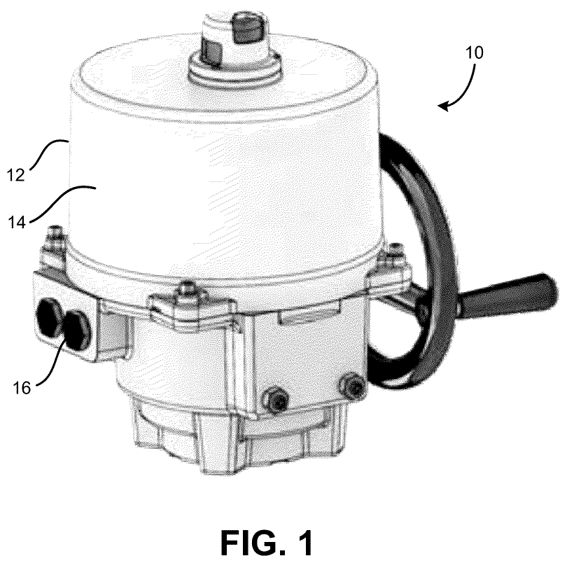

Electric actuators are utilized in a number of applications and processes to control the opening and closing of various structures, such as valves and dampers in fluid systems. An example of an actuator 10 is shown in FIG. 1, and has an outer housing 12 which encloses a motor 14 that drives a shaft or other similar structure. The housing 12 includes ports 16 for receiving a power supply, typically from a mains power line. The motor 14 is typically a DC motor rated up to 100 in-lbs. The actuators 10 are specifically designed to operate in low-power environments such as solar-powered remote valve systems, fugitive emission control systems, and other applications requiring, for example, low Amp power draws from off-grid power sources.

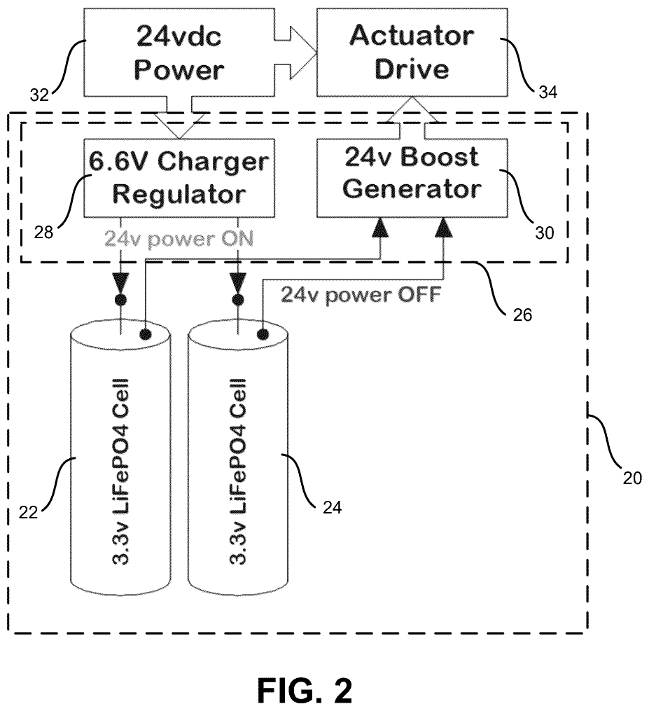

In one aspect of the invention, an internal use battery pack 20—illustrated schematically in FIG. 2—includes a first 3.3 v LiFePO4 cell 22 and a second 3.3 v LiFePO4 cell 24 coupled to a management and distribution control board 26 that includes, among other features, first circuitry 28 (sometimes referred to as the “charger regulator” or “charging circuit” or similar language) for regulating the charging and discharging of the cells 22, 24, and second circuitry 30 (sometimes referred to as the “boost circuit” or “boost generator” or similar language) for boosting an output of the cells 22, 24. FIG. 2 also illustrates connection of the battery pack 20 with the mains power supply 32 and the actuator drive 34.

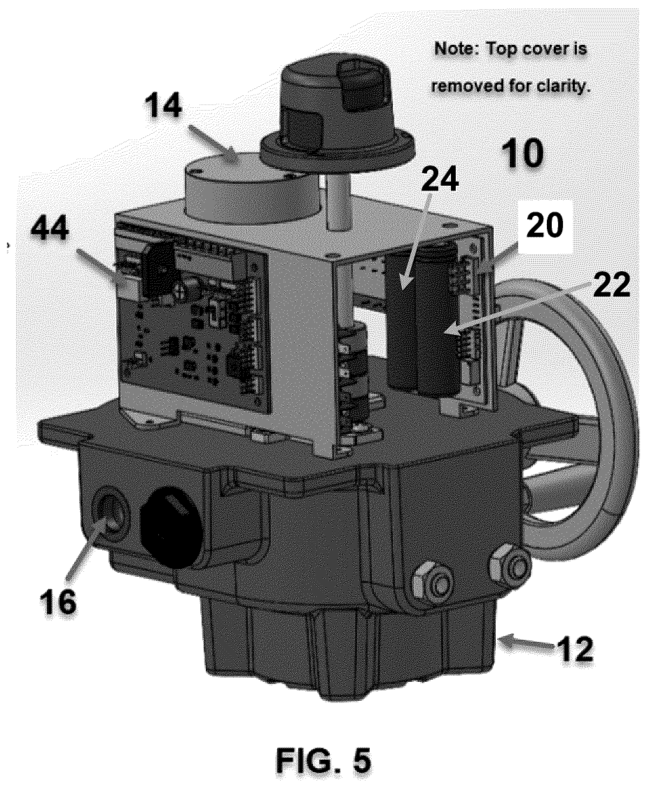

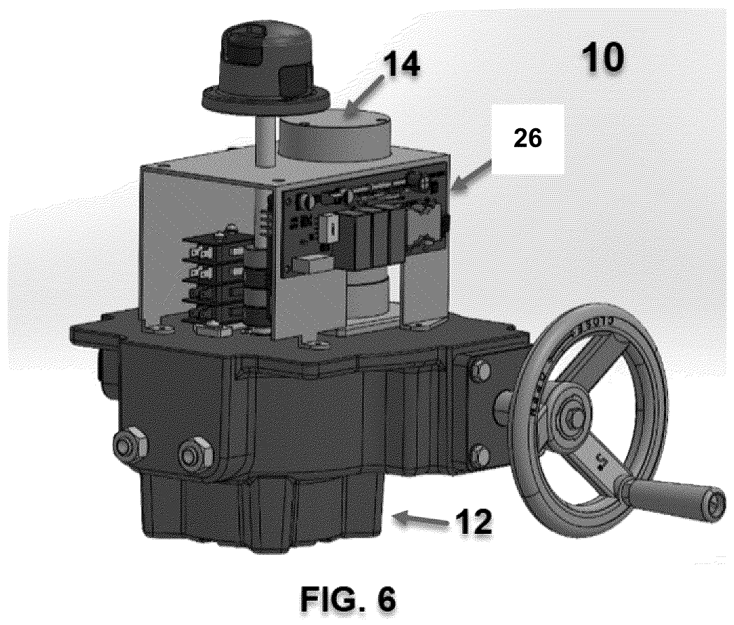

The battery pack 20 is designed as a modular unit that can be installed in the housing 12 of an actuator 10—either at the time of assembly of the actuator 10 or at a later time after the actuator has been installed in the field. The LiFePO4 cells 22, 24 can be in shrink-wrapped packaging. More than one of the battery packs 20 can be interconnected with keyed harnesses. FIGS. 5 and 6 show the actuator 12 with the outer cover removed. Components of the battery pack 20 are shown installed in the actuator 12.

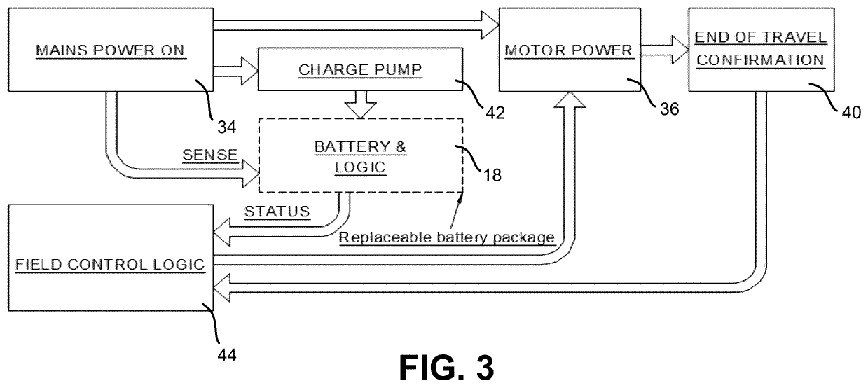

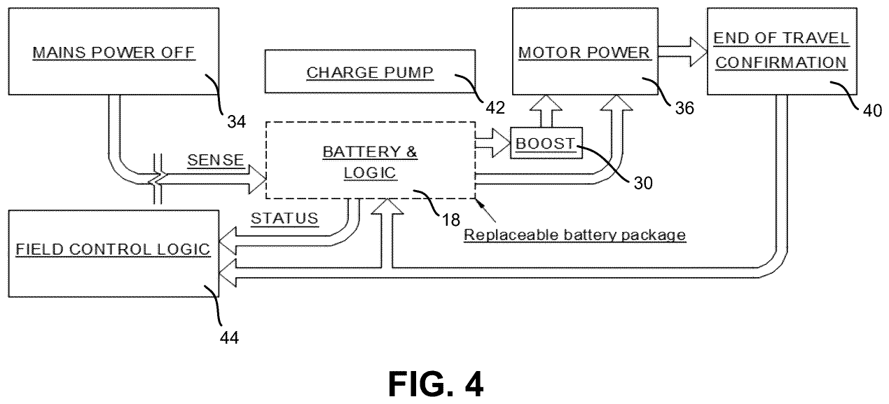

FIGS. 3 and 4 schematically illustrate operation of the battery pack 20 in an actuator 10 during normal operation and during a mains power loss, respectively. In normal operation shown in FIG. 3, the mains power line 32 provides power to drive the motor 34 of an actuator to open or close a valve, damper or other similar structure in a fluid flow system which will provide an end of travel signal 40 when complete. The mains power line 32 will also provide power to a charging pump 42 which provides power to the internal battery pack 20 to maintain the charge on the LiFePO4 cells 22, 24 in the pack 20. As shown in FIG. 3, the battery pack 20, actuator motor 34 and end of travel signal 40 are coupled to a logic controller 44 which controls operation of the fluid flow of the processing system.

As shown in FIG. 4, during a power loss situation, power from the mains power line 32 is no longer provided to either the actuator motor 34 or the battery pack charging pump 42. This loss of power is sensed by the battery pack 20 which initiates supplying power to the actuator motor 14 from the LiFePO4 cells 22, 24. This is done via the battery pack's 20 boost circuitry 30. The power supplied from the boosted LiFePO4 cells 22, 24 allows the actuator 10 to move the valve, damper or other structure it is connected to, into a closed, i.e., fail safe, position. The end of travel confirmation 40 is provided to the battery pack 20 which can then stop providing power to the motor 14.

The control board 26 can be configured to have several fault modes for handling certain situations that may be encountered. The fault modes can be monitored and alert the processing system of the particular fault sensed and the actions taken or needed by the battery pack 20. For example, Fault mode 1 can indicate a mains power failure (as described). The Fault mode activates when the mains power coming into the control board 26 is lost and resets when the incoming power is restored.

In an example illustrating Fault mode 1: an actuator powered by a facility's mains power can be positioning a valve attached to the actuator to control flow of water through a piping system that regulates condenser water to a chiller cooling an agricultural storehouse. If power is lost due to a transmission line breakage, thousands of gallons of process water would be lost due to gravity flow if the valve stays open. In this instance, the battery pack comes online and closes the valve to prevent the loss. The Fault mode 1 is activated and alerts the facility's automation system of the power loss, and that the internal battery pack has taken control and closed the valve. Upon restoration of power, the actuator comes back on mains power and the fault is cleared, thereby returning control of the valve to the facility control system.

Fault mode 2 can be activated when the battery pack 20 is outside specified temperature limits. This can be useful because the LiFePO4 cells 22, 24 will not charge if the ambient temperature is above or below a certain temperature (e.g., above 113 degrees Fahrenheit, or below 32 degrees Fahrenheit for the cell size described herein). If mains power is lost in one of these situations, the battery pack 20 will still attempt to power the actuator 10, however, the valve may not close all the way depending on the remaining charge of the LiFePO4 cells 22, 24. The fault mode can be cleared when the ambient temperature is back within the specified limits. In order to activate this mode, the control board is connected to or otherwise receives information from a temperature sensing device, or is provided with circuitry to sense if the cells are charging.

In an example illustrating Fault mode 2: an actuator is installed in a physical plant piping system controlling hot water. Ventilation in the facility can be challenged by a blocked outside air louver causing ambient temperature to rise in the facility above the LiFePO4 cells 22, 24 upper limit during the summer months. The actuator's internal temperature sensors detect the higher-than-spec temperature and trigger a Fault mode 2 alarm signal from the battery pack 20 to the facility's building control system. This provides information indicating a possible reduced battery performance in the event of a power loss.

Fault mode 3 can be activated if the LiFePO4 cell drops below a specified voltage value (e.g., 2.2 Volts). This can be set up as a hard set fault that once set cannot be reset. This fault will indicate the battery cells are likely damaged and need to be replaced.

In an example illustrating Fault mode 3: the internal battery pack 20 monitors the health of the LiFePO4 cells in the pack. At some point, if the mains power is constantly being interrupted or is off more than it is on, the battery cells may not be able to properly charge or hold a charge. When one or both of the cells in the pack have a voltage below the set limit the Fault 3 alarm is tripped, indicating a permanent battery failure. The actuator will continue to operate under mains power, and will continue to provide available power reserves to energize the drive motor and return the actuator to the selected fail-safe position, but may NOT have the required reserves to complete the movement. The Fault 3 alarm can be monitored by the building automation system which indicates the actuator's internal battery pack is comprised and must be replaced.

In operation in one aspect of the invention, an actuator 10 is installed in a fluid low processing system and a fail-safe position is set. The fail-safe position can be either CW (clock-wise—which typically closes the valve or damper) or CCW (counterclock-wise—which typically opens the valve or damper) depending on the proper positioning required by the system in the event of a mains power failure. If not already provided, one or more battery packs 20 are installed in the housing 12 of the actuator 10.

Power from the mains power line is supplied to power the actuator 10 during normal operation of the system, and is also to use to charge the LiFePO4 cells 22, 24 in the battery pack 20 through a charger regulator or circuit 28 in the control board 26 of the battery pack 20. The LiFePO4 cells 22, 24 are in a parallel connection-allowing individual cells to be charged and monitored separately. System logic on the control board 26 controls connection of the LiFePO4 cells 22, 24 and the boost circuit 30 on the control board 26. The actuator 10 operates as dictated by the field control system (see e.g., 44 in FIG. 3). In this situation motor power (for the actuator motor 14) is provided by the mains power source and none is provided by the battery pack 20. The charger regulator 28 provides charge power to the LiFePO4 cells 22, 24 from the mains power line to maintain a 3.3-3.7 vdc ready-state charge. The field logic control system 44 can monitor the battery cells 22, 24 status by connection to Fault 1, 2 and 3 contacts on the control board 26.

When the mains power supply is off, logic on the control board 26 senses the power loss and then sets a Fault 1 relay and connects the LiFePO4 cells 22, 24 to provide motor power. The charger regulator 28 stops charging the LiFePO4 cells 22, 24 and the boost generator 30 boosts the output from the cell(s) to the voltage necessary to drive the motor 14 to the selected fail-safe direction to an end-of-travel position. The boost generator 30 also provides power to the logic circuits on the control board 26 until the end-of-travel has been reached, then turns off the battery pack 20.

When the mains power is on, it supplies 24 vdc to the actuator to drive the motor, which can be a brushless DC motor, as well as feed into the battery pack's charging circuit 28 to provide power to charge the LiFePO4 cells 22, 24. The charging circuit 28 converts the 24 vdc into 3.6 vdc and monitors the cell's health to maintain optimum battery cell charge levels. When mains power is lost, the charging circuit 28 is no longer active and discharge circuitry in the control board 26 connects the two 3.3 vdc cells 22, 24 together (to obtain 6.6 vdc) and connects to the boost generator 30 which directs the 6.6. vdc through a high-frequency inductor and a capacitor to generate 24 vdc which powers the motor 14 to drive the valve or damper to the intended fail-safe position.

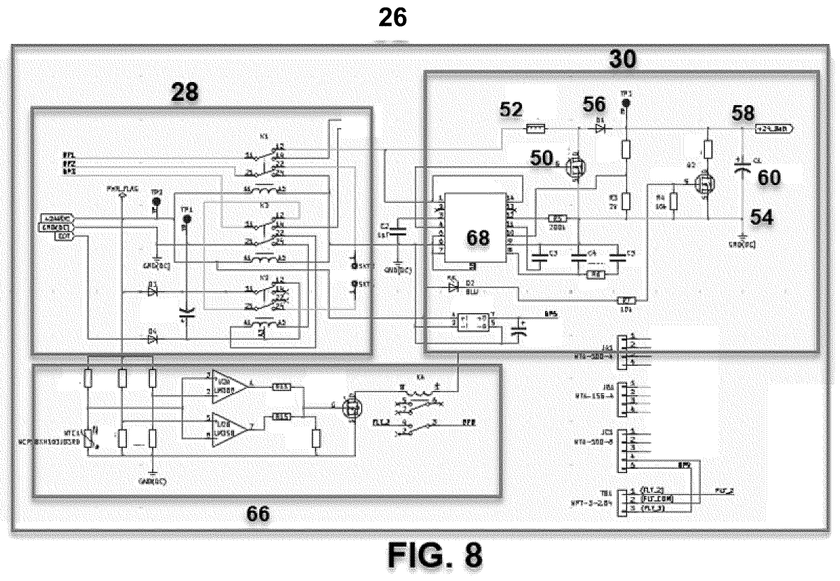

In one aspect of the invention, the boost generator 30 works in two phase—i.e., (1) MOSFET on and (2) MOSFET off. FIG. 8 provides a circuit diagram of the boost generator 30.

In the MOSFET on phase, the MOSFET gate 50 is pulled high by the boost generator 30. This allows current to flow through an inductor 52 straight to ground 54 with minimal resistance. The inductor 52 charges as the current continues to pass through it, allowing more current through over time.

In the MOSFET off phase, the MOSFET gate 50 is pulled low by the boost generator 30 and now blocks the current from going through the inductor 52 to ground 54. The charge left in the inductor 52 is now forced through a diode 56 to the output 58 and a smoothing capacitor 60. Since the inductor 52 was able to charge so fast during the MOSFET on phase, this charge going to the capacitor 60 results in a larger voltage across the capacitor 60. Once most of the charge from the inductor 52 is consumed by the capacitor 60 the boost generator 30 turns back to the MOSFET on phase.

FIG. 8 also provides circuitry for thermal limits monitoring 66.

The logic on the control board 26 provides command signals to the motor 14 drive system in the actuator 10 as determined by the fail direction established during installation and set up (e.g., CW or CCW). End-of-travel switches in the actuator tell the discharge circuity in the control board 26 when the actuator 10 has positioned the valve or damper in the fail-safe position, and disconnects the LiFePO4 cells 22, 24 from the output 58. The entire system stays in this mode until mains power returns. Also during this mode, auxillary contacts in the actuator (dry contacts) can be read by the site's automation system (or PLC) as an actuator position status even without any power connected.

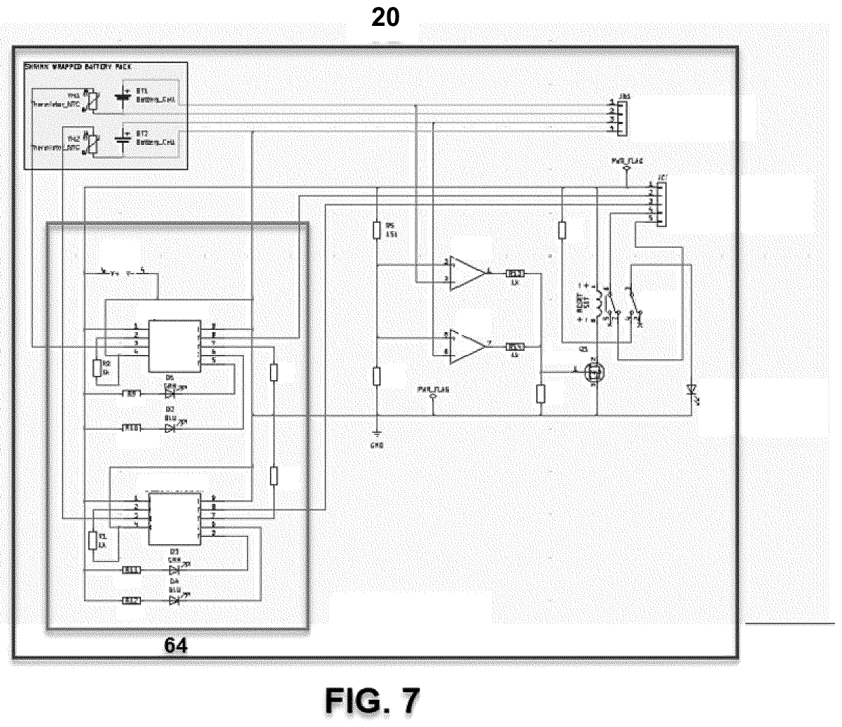

FIG. 7 shows a battery cell management system and provides a schematic diagram of a battery pack 20 and contains battery management circuitry with temperature, voltage, and current management 64.

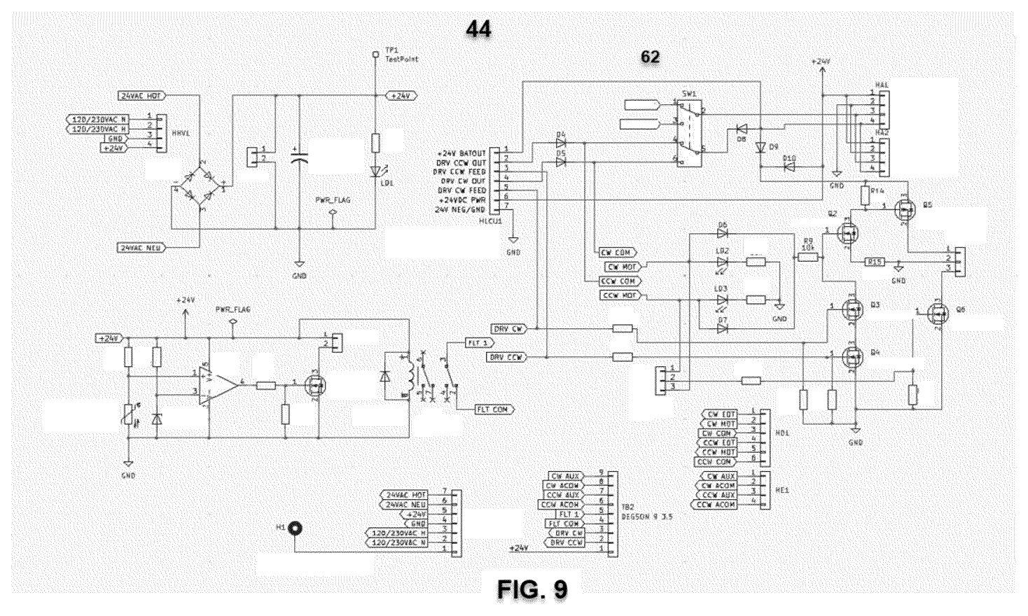

FIG. 9 provides a detailed schematic diagram of a field response controller 62 which can be on the control board 44.

The battery backup system of the present invention is preferably formed as compact modules that are designed to fit in or near the actuator.

Many modifications and variations of the present invention are possible in light of the above teachings. It is, therefore, to be understood within the scope of the appended claims the invention may be protected otherwise than as specifically described.

We claim:

1. An internal battery backup system for an electric actuator connected to a valve or damper having a housing with an internal cavity, the system comprising:
a first Lithium-Iron-Phosphate cell configured for placement in the internal cavity of the actuator;
a control board coupled to the first Lithium-Iron-Phosphate cell having circuitry for sensing a fault condition and activating the first Lithium-Iron-Phosphate cell to provide power to initiate fail-safe positioning by the actuator.

2. The internal battery backup system of claim 1 further comprising a second Lithium-Iron-Phosphate cell configured for placement in the internal cavity of the actuator coupled to the control board.

3. The internal battery backup system of claim 1 wherein the control board is coupled to the mains power line providing power to the actuator.

4. The internal battery backup system of claim 3 wherein the control board is configured to sense a loss of power in the mains power line.

5. The internal battery backup system of claim 4 wherein the control board activates the first Lithium-Iron-Phosphate cell when a loss of power is sensed in the mains power line.

6. The internal battery backup system of claim 1 wherein the control board is coupled to a temperature sensing device.

7. The internal battery backup system of claim 6 wherein the control board is configured to compare a temperature reading from the temperature sensing device with a set limit temperature range and to provide a signal if the temperature reading is outside the set limit temperature range.

8. The internal battery backup system of claim 1 wherein the control board is configured to determine a voltage level of the first Lithium-Iron-Phosphate cell and to provide a signal if the voltage level of the first Lithium-Iron-Phosphate cell falls below a set limit.

9. The internal battery backup system of claim 2 wherein the first Lithium-Iron-Phosphate cell and the second Lithium-Iron-Phosphate cell are coupled in parallel.

10. The internal battery backup system of claim 1 wherein the control board is coupled to field control system.

11. The internal battery backup system of claim 1 wherein the control board includes a charging circuit and a discharge circuit.

12. The internal battery backup system of claim 11 wherein the control board includes to a voltage boost system.

13. The internal battery backup system of claim 1 wherein the control board is coupled to an end-of-travel switch.

14. The internal battery backup system of claim 13 wherein the control board de-actives the first Lithium-Iron-Phosphate cell when the control board senses activation of the end-of-travel switch.

15. The internal battery backup system of claim 12 wherein a direct current voltage from the first and second Lithium-Iron-Phosphate cells is directed through an inductor to a capacitor in the voltage boost system.

16. The internal battery backup system of claim 15 wherein the voltage boost system includes a MOSFET gate that enables current to flow through the inductor to ground when the boost system is in a drain phase.

17. The internal battery backup system of claim 16 wherein the MOSFET gate enables current to flow through the inductor to the capacitor when the boost system is in a charge cycle.

18. An internal battery backup system for an electric actuator comprising:
a first Lithium-Iron-Phosphate battery pack containing a first Lithium-Iron-Phosphate cell and a second Lithium-Iron-Phosphate cell; and,
a power and management unit connected to the first Lithium-Iron-Phosphate battery pack configured to charge the cells in the Lithium-Iron-Phosphate battery pack from a mains power supply and to discharge the cells to the electric actuator upon sensing a fault condition in the mains power supply.

19. The internal battery backup system of claim 18 further comprising a second Lithium-Iron-Phosphate battery pack containing a first Lithium-Iron-Phosphate cell and a second Lithium-Iron-Phosphate cell connected to the power and management unit.

20. The internal battery backup system of claim 18 further comprising a boost system in the power and management unit which directs current from the cells in the first Lithium-Iron-Phosphate battery pack through a capacitor to provide a voltage to the actuator greater than a voltage of the battery pack.
